(19) United States
(12) Patent Application Publication
(10) Pub. No.: US 2014/0033442 A1
(43) Pub. Date: Feb. 6, 2014

(54) Cutting Tool

(71) Applicant: Torris L. Bethea, Havana, FL (US)

(72) Inventor: Torris L. Bethea, Havana, FL (US)

(21) Appl. No.: 13/567,113

(22) Filed: Aug. 6, 2012

(51) Int. Cl. A45D 44/00; B26B 3/00

(52) U.S. Cl. 7/158; 30/289

(57) ABSTRACT

A cutting tool designed to easily and efficiently remove a hair weave. The tool has a main body including a fully integrated handle, central portion and slide portion. The central portion has a top edge and the slide portion has a guiding edge and a pointed tip. The main body houses a blade which is partially enclosed by the central portion of the main body and exposed along a sharpened edge along the top edge of the central portion. The sharpened edge of the blade extends into the guide edge of the slide. The blade is designed to cut the thread of a hair weave in order to remove it from the existing hair.

### CROSS-REFERENCES TO RELATED APPLICATIONS

Not Applicable

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of beauty products. More specifically, the invention is a device which assists in the removal of artificial or natural hair integrations.

2. Description of the Related Art

Hair extensions are commonly used to alter the appearance of human hair by adding artificial or natural hair to existing hair. There are many different techniques for attaching the extensions. Bonding is one approach in which the extensions axe adhered to the hair using glue or another adhesive. Another popular method is tracking, in which the natural hair is braided and sewn down and the extensions are sewn onto the braids. The extensions can consist of a few tracks or the whole head can be braided for full head weave.

In the hair weave industry, women spend a large portion of time and money having hair extensions sewn into their existing hair. A “hair weave” can take a considerable amount of time to sew in. The weave often remain for months, with a series of trips back to the salon for washing, conditioning and tightening. When it comes time to remove the hair weave, the individual often must return to the salon to have the extensions cut away from the existing hair.

Removing the hair weave typically involves using a pair of scissors or a razor blade. The strand of threading that connects the extensions to the existing hair is lifted slightly upwards away from the scalp and the thread is cut. This is repeated until the extensions can be pulled away from the existing hair. The process of removing the hair weave can take anywhere from an hour to several hours. It is difficult for the individual with the hair extensions to remove the threading on their own. This is due to the fact that the thread is located close to the scalp and is close to the same color as both the existing hair and the extension. It is often the case that some existing hair or the hair weave can be cut instead of the threading itself.

Therefore what is needed is a hair weave cutting tool that allows the user to lift the thread away from the scalp, identify the material picked up by the device and slice through the thread safely and efficiently.

### BRIEF SUMMARY OF THE INVENTION

A cutting tool designed to easily and efficiently remove a hair weave. The tool has a main body including a handle, a central portion and a slide portion. The handle, central portion and slide are preferably fully integrated together. A blade is partially enclosed with the central portion of the main body. The blade is designed to cut the thread of the hair weave in order to remove it from the existing hair.

The exposed edge of the blade extends along the top edge of the central portion of the main body meeting the slide at the base of the guide edge. As the thread is selected by the pointed tip of the slide, the user can view and ensure that only thread (as opposed to existing hair) was selected. The guide edge of the slide directs the thread towards the edge of the blade. When the thread meets the sharpened edge of the blade, the thread is cut efficiently and safely.

### BRIEF DESCRIPTION OF THE SEVERAL VIEWS OF THE DRAWINGS

FIG. 1 is a perspective view, showing the present invention.

FIG. 2 is an expanded view, showing a close up of the slide and central portion of the present invention.

FIG. 2 is a perspective view, showing the present invention selecting a portion of thread.

FIG. 3 is a perspective view, showing the present invention cutting a portion of thread.

FIG. 4 is a perspective view, showing the present invention selecting a portion of existing hair.

FIG. 5 is a cut away view, showing the blade attachment point and placement of blade within the device.

FIG. 6 is a perspective view, showing an alternate embodiment of the present invention where the blade can be ejected from the device and replaced.

FIG. 7 is a perspective view showing a second alternate embodiment of the present invention.

### REFERENCE NUMERALS IN THE DRAWINGS

| | |
|---|---|
| 10 cutting tool | 12 blade |
| 14 slide | 16 handle |
| 18 central portion | 20 pick |
| 22 thread | 24 hair extensions |
| 26 existing hair | 28 scalp |
| 30 attachment point | 32 release trigger |
| 34 main body | 36 pointed tip |
| 38 guide edge | 40 top edge |

### DETAILED DESCRIPTION OF THE INVENTION

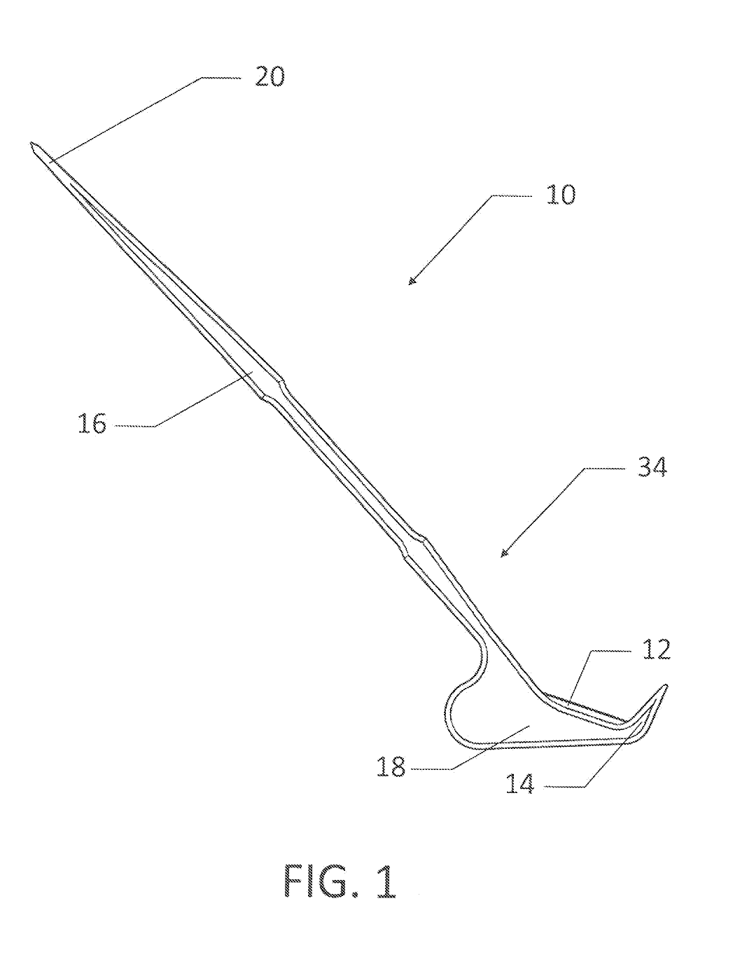

A perspective view of cutting tool 10 is illustrated in FIG. 1. The cutting tool 10 is adapted to remove traditional hair extensions which are sewn, using threading or the like, to an individual's existing hair, typically close to their scalp. As will be described herein, when removing a hair weave or extension it is important that the user can both cut the thread without injuring the scalp and identify that only thread is being cut (as opposed to existing hair).

As referenced in FIG. 1, cutting tool 10 includes a main body 34 having a handle 16, central portion 18 and slide 14. Blade 12 is securely housed in central portion 18. Handle 16 can optionally include a hair pick 20 at the end, so that the user can part the hair by turning the tool 10 around. Slide 14 extends away from body 18, preferably at an obtuse angle. Handle 16, central portion 18 and slide 14 preferably form one integrated piece.

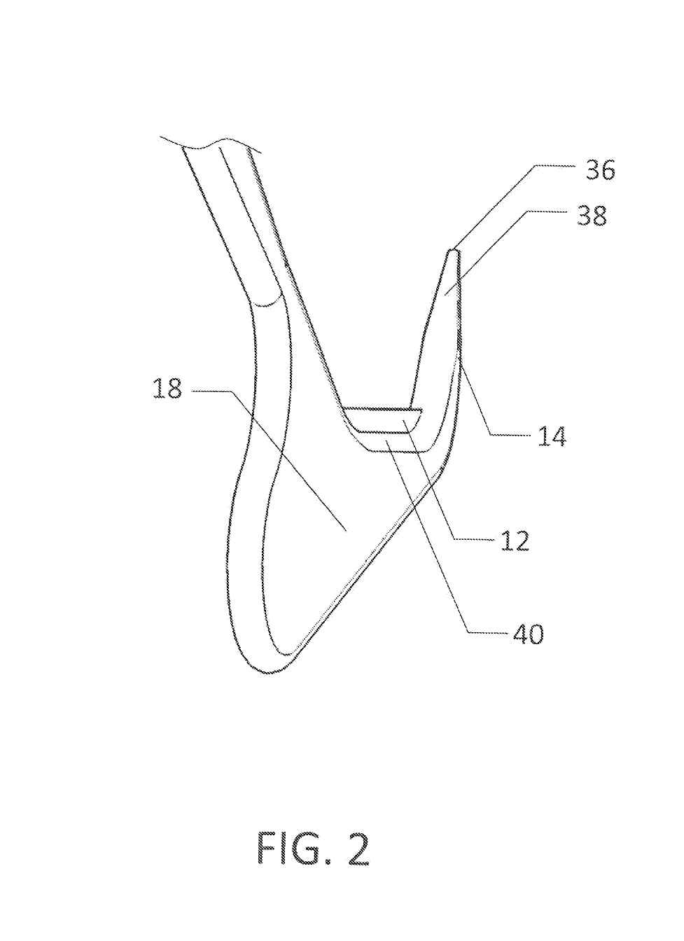

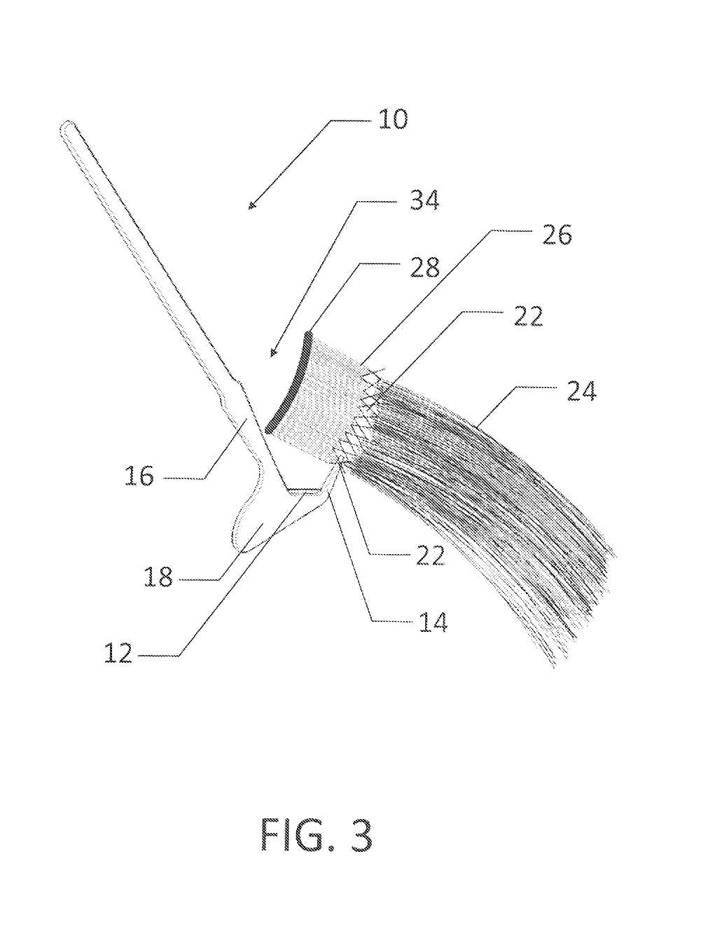

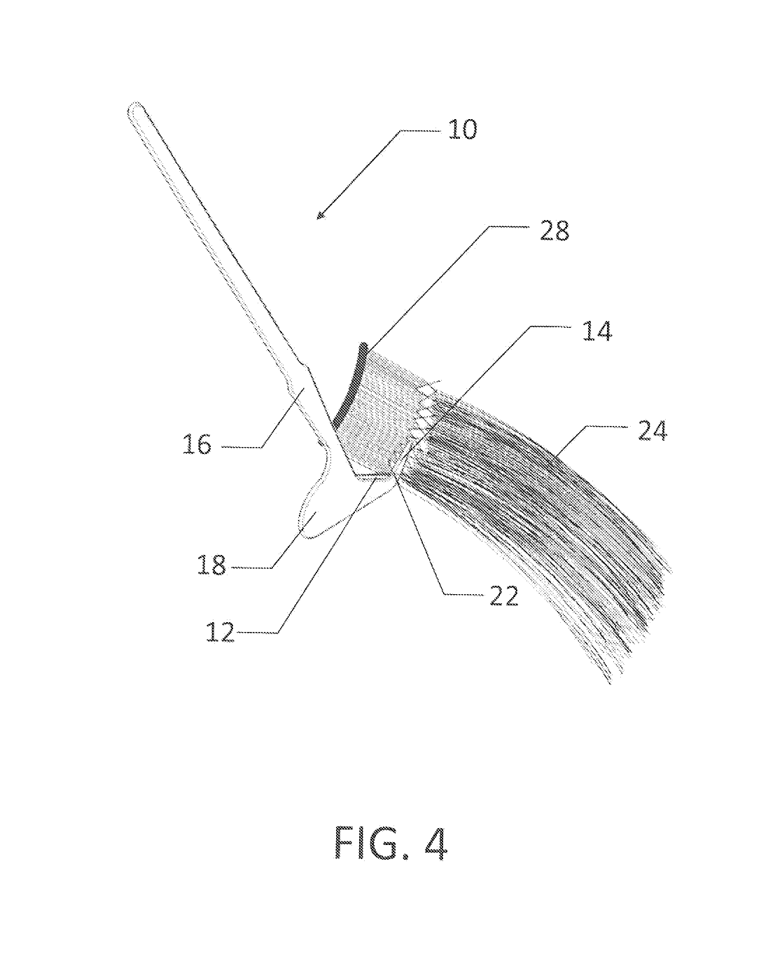

A close up view of only slide 14 and central portion 18 of the present cutting tool 10 is illustrated in FIG. 2. Slide 14 more particularly includes a pointed tip 36 such that the tip is capable of selecting a piece of thread (further illustrated in FIG. 3) and a guide edge 38. Guide edge 38 operates to guide a selected piece of thread towards blade 12. Although blade 12 is housed within central portion 18, the sharpened edge of blade 12 extends along top edge 40 of central portion 18 and embeds into guide edge 38 of slide 14. As further described below, the positioning of the sharpened edge of blade 14 embedding into guide edge 38 of slide 14 is important to enable the efficient cutting of the selected piece of thread.

FIG. 3 shows cutting tool 10 in use. A representation of an individual's hair and weave is shown where the individual's scalp 28 is illustrated by a simple line. Existing hair 26 extends from scalp 28. Thread 22 connects existing hair 26 to hair extensions 24. For purposes of simplicity, thread 22 is shown as a series of crossed lines. However, in use, the hair weave would be more intricate and could also utilize threading through a net covering the existing hair. Despite the different methods in which the hair weave can be sewn together, cutting tool 10 can be used in the same general manner to efficiently and safely remove the hair extensions.

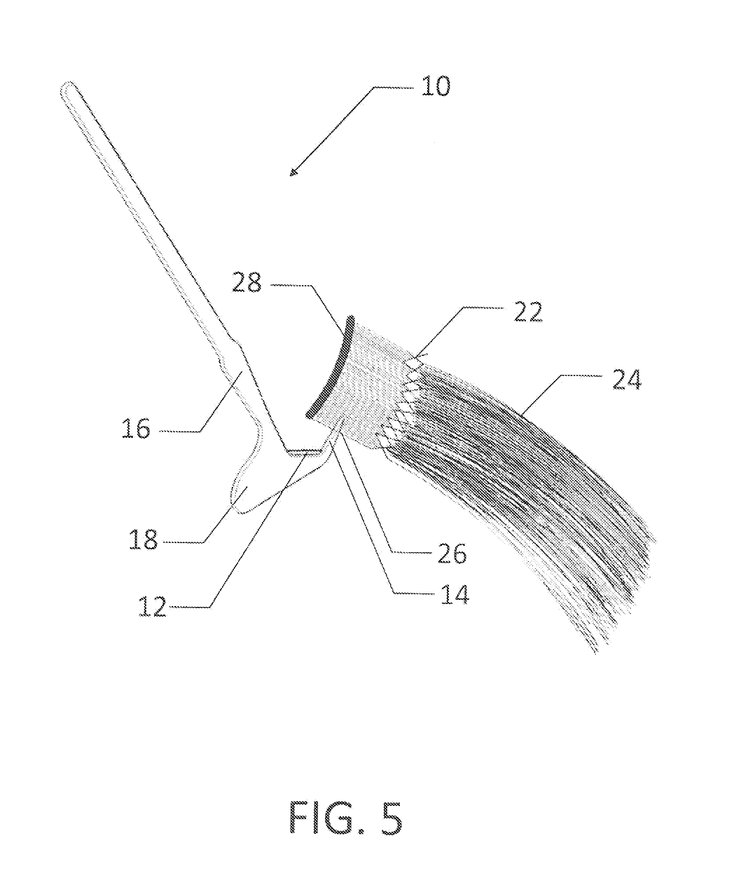

As shown in FIG. 3, slide 22 is used to select a strand of thread 22. The user can identify that a piece of thread 22 has in fact been selected by viewing slide 14. Slide 14 acts to lift thread 22 away from scalp 28 and guide thread 22 towards blade 12. The user's scalp and head are protected from the sharp edge of blade 12, which remains along the top edge 40 of central portion 18 (illustrated in FIG. 2) away from the user's scalp 28. Thus, main body 34 sits between scalp 28 of the user and the sharp edge of blade 12. As thread 22 reaches blade 12, thread 22 is easily sliced through as depicted in FIG. 4. The tension and force needed to quickly slice through thread 22 is minimal due to the angular placement of blade 12 where it embeds within slide 14. The user can quickly and easily begin a second cut by picking another portion of thread 22.

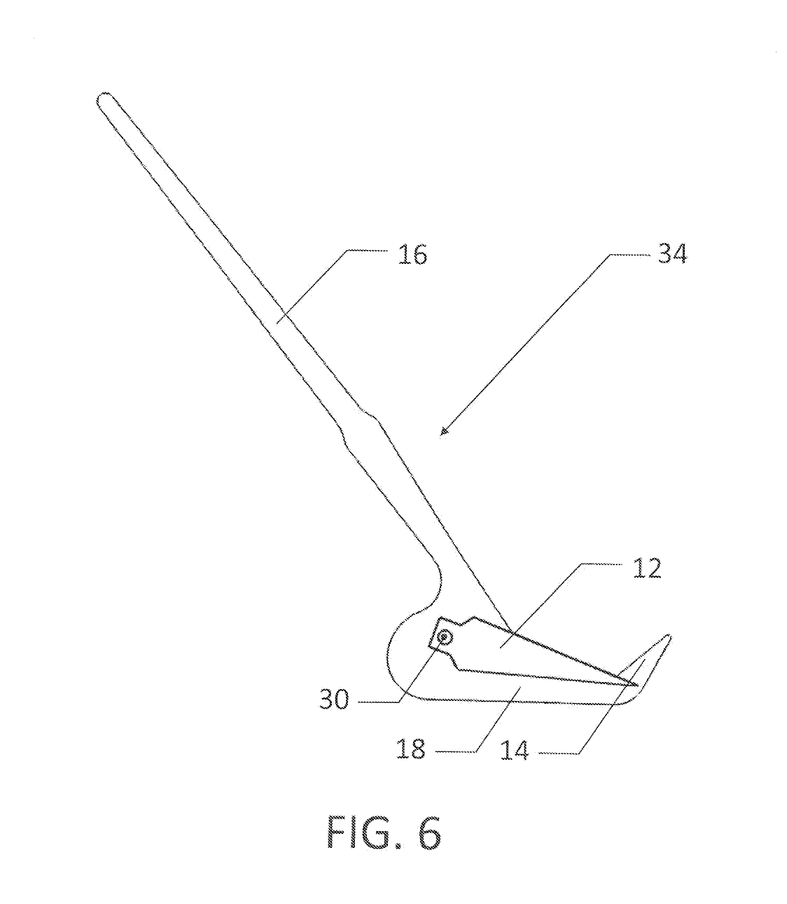

The existing hair 26, thread 22 and hair extensions 24 are typically of the same color or a very similar one. It can therefore be difficult to always select a piece of thread 22 to cut. At times the user may select a portion of existing hair 26 or hair extension 24. FIG. 5 demonstrates the selection of a piece of existing hair 26. Once the piece of existing hair 26 is selected by slide 14 it becomes more visible to the user. Because blade 12 does not meet guide edge 38 (shown in FIG. 2) of slide 14 close to the pointed tip of slide 14 the user can simply retract cutting tool 10 and select again without severing the existing hair 26. It is important that slide 14 is of such a length that it allows the user to view the material selected prior to the material reaching blade 12. Additionally, cutting tool 10 can optionally be made of a bright color in order to create more of a contrast between cutting tool 10 and the existing hair 26, thread 22 and/or hair extensions 24. However, the present cutting tool 10 should not be limited to any one color.

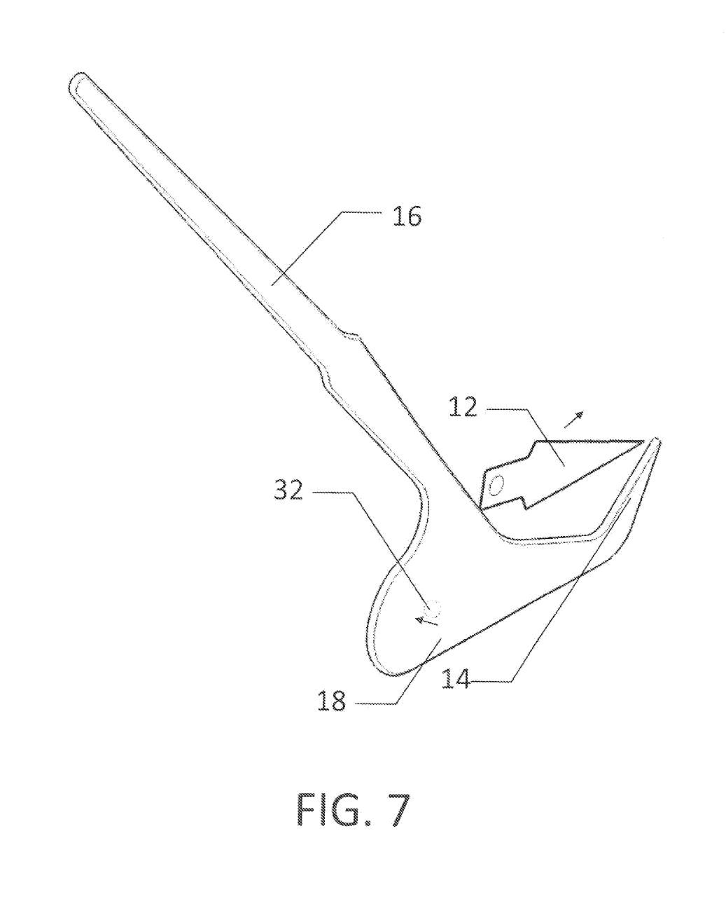

FIG. 6 is a cut away view with one side of main body 34 cut away to illustrate the placement of blade 12 within cutting tool 10. Blade 12 can attach within or on cutting tool 10 in any known manner such that it remains angularly displaced from slide 14. Attachment point 30 of blade 12 is shown set in cutting tool 10 to securely fix blade 12 in place.

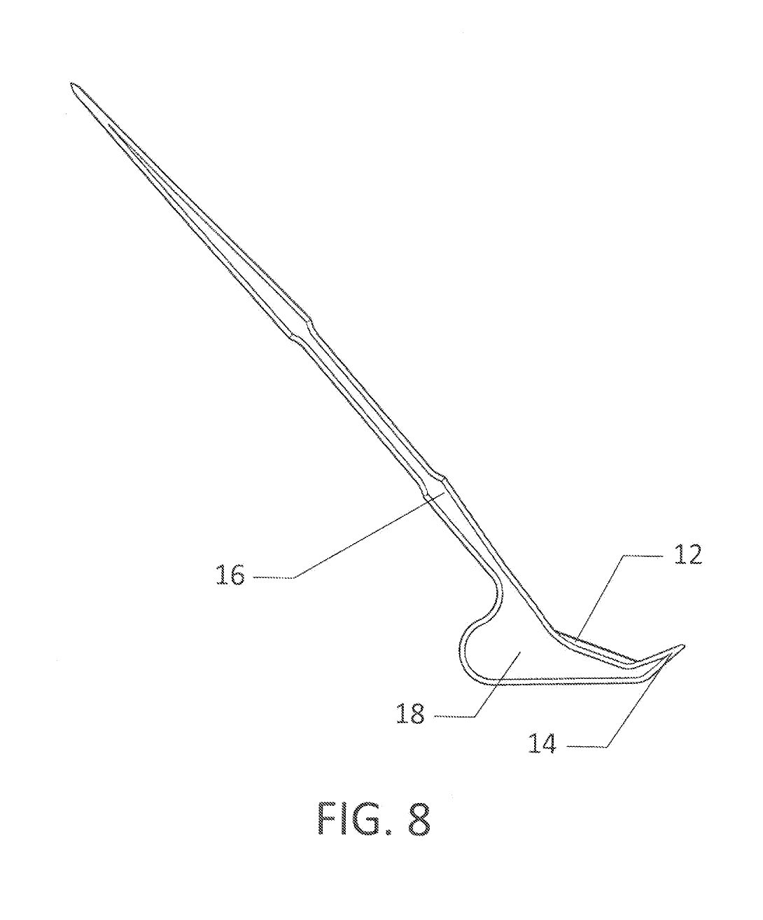

While it is preferable that blade 12 remains securely attached at all times within main body, an alternate embodiment is shown in FIG. 7, wherein the blade 12 is removable and replaceable. In the alternate embodiment a release trigger 32 is provided on body 18 of cutting tool 10. Release trigger 32 acts to eject blade 12. An arrow shows the direction in which blade 12 is released. This allows the user to change to a sharper blade upon dulling of a blade after use.

FIG. 8 is a perspective view showing a second alternate embodiment of the present invention. In the alternate embodiment slide 14 only slightly angles away from central portion 18.

The preceding description contains significant detail regarding the novel aspects of the present invention. It should not be construed, however, as limiting the scope of the invention but rather as providing illustrations of the preferred embodiments of the invention. As an example, a release trigger may be provided in order to change blades. Additionally, an optional hair pick 20 may be placed at the end of handle 16. Thus, the scope of the invention should be fixed by the following claims, rather than by the examples given.

Having described my invention, I claim:

1. A cutting tool for use to remove a hair extension sewn into an individual's existing hair by use of at least one thread, further comprising:
a. a main body including:
i. a handle;
ii. a central portion having a top edge;
iii. a slide having a guide edge and a pointed tip;
b. wherein said main body houses a blade which extends along said top edge of said central portion;
c. wherein said pointed tip of said slide is capable of selecting said at least one thread; and
d. wherein said guide edge of said slide directs said at least one thread toward said blade which sits proximate said guide edge of said slide.

2. The cutting tool of claim 2, wherein said guide edge of said slide is of such a length that any material selected is visible along said guide prior to said material meeting said blade.

3. The cutting tool of claim 1, wherein said slide is angularly displaced from said central portion.

4. The cutting tool of claim 1, wherein said handle portion further comprises a pick.

5. The cutting tool of claim 1, wherein said blade is securely attached within said main body.

6. The cutting tool of claim 1, wherein said blade is removable and replaceable.

7. The cutting tool of claim 1, wherein said central portion, said slide and said handle are fully integrated.

8. The cutting tool of claim 1, wherein said blade is positioned such that as said at least one thread slides downward along said slide, said blade meets said at least one thread prior to said at least one thread reaching said central portion of said main body.

9. A cutting tool for use to remove a hair extension sewn into an individual's existing hair by use of thread, further comprising:
a. a main body including:
i. a handle;
ii. a central portion having a top edge;
iii. a slide having a guide edge and a pointed tip;
b. wherein said central portion houses a blade in which a sharpened edge of said blade extends along said top edge of said central portion and embeds within said guide edge of said slide;
c. wherein said pointed tip of said slide is capable of selecting said thread; and
d. wherein said guide edge of said slide directs said thread toward said blade which sits proximate said guide edge of said slide.

10. The cutting tool of claim 9, wherein said handle further comprises a pick.

11. The cutting tool of claim 9, wherein said handle, said central portion and said slide are fully integrated.

12. The cutting tool of claim 9, wherein said slide has a length such that a user can view a selection of a material prior to slicing said selection of material.

13. The cutting tool of claim 9, wherein said blade is securely attached within said main body.

14. The cutting tool of claim 9, wherein said blade is removable and replaceable.

15. A cutting tool for use to remove a thread sewn into and between existing hair and a hair extension, wherein said thread, existing hair and hair extension are all of a material, further comprising:
a. a main body including:
i. a handle;
ii. a central portion having a top edge;
iii. a slide having a guide edge and a pointed tip;
b. wherein said central portion houses a blade in which a sharpened edge of said blade extends along said top edge of said central portion and embeds within said guide edge of said slide approximately perpendicular to said guide edge of said slide;
c. wherein said pointed tip of said slide is capable of selecting said thread; and
d. wherein said guide edge of said slide directs said thread toward said blade which sits proximate said guide edge of said slide.

16. The cutting tool of claim 15, wherein said guide edge of said slide is of a length wherein a user can select said material, view said material and deselect said material meeting said blade.

17. The cutting tool of claim 15, wherein said handle further comprises a pick.

18. The cutting tool of claim 15, wherein said handle, said central portion and said slide are fully integrated.

19. The cutting tool of claim 15, wherein said blade is securely attached within said main body.

20. The cutting tool of claim 15, wherein said blade is removable and replaceable.
